(19) United States
(12) Patent Application Publication
(10) Pub. No.: US 2012/0030288 A1
(43) Pub. Date: Feb. 2, 2012

(54) SYNCHRONIZING USER CONTENT IN A COLLABORATIVE SESSION

(75) Inventors: Eric John Burckart, Raleigh, NC (US); Andrew Ivory, Wake Forrest, NC (US); Ashwin Bhaskarrao Manekar, Morrisville, NC (US); Aaron Kyle Shook, Raleigh, NC (US)

(73) Assignee: INTERNATIONAL BUSINESS MACHINES CORPORATION, Armonk, NY (US)

(21) Appl. No.: 12/844,497

(22) Filed: Jul. 27, 2010

(51) Int. Cl. G06F 15/16

(52) U.S. Cl. 709/205

(57) ABSTRACT

Collaborative sessions, including website browsing sessions, are supported where particularized content of a first user is shared with a second user in order to synchronize a collaborative session attended by the first user and the second user. The particularized content may contain information generated during the session, information regarding previous sessions, and preferences indicated by a participant in the collaborative session or a system administrator. The particularized content may be synchronized on a peer-to-peer basis as well as through server intervention. The user for which the particularized content is targeted may maintain controls over when and to whom the particularized content may be shared.

### BACKGROUND

The present invention relates to shared collaborative sessions where two or more users may each participate in or experience a server sponsored session. Methods, systems, apparatus, and articles of manufacture are provided wherein content particularized for a first user is selectively shared with a second user in order to provide synchronization of the collaborative session attended by the first user and the second user.

Browsing websites is a popular activity in contemporary society. A user may visit a website to view the information provided thereon or to interact with the services available from the website. The information provided by websites is innumerable and can include reference materials, news materials, and literature. The services provided by websites are also innumerable and can include retail marketing, wholesale marketing, and financial services.

In certain instances a website providing information or services may particularize information being provided to the user of the website. This particularization may include customized banners, recent histories, and selected preferences. Being unique to the particular user, the particularized information would not be presented to or available to another user accessing that same website. Instead, the particular information is intended to enhance the browsing experience of the user.

### BRIEF SUMMARY

Methods, apparatus, and articles of manufacture are included in embodiments of the invention. These embodiments can include collaborative sessions, including website browsing sessions, where particularized content for a first user is shared with a second user in order to synchronize a collaborative session attended by the first user and the second user. The particularized content may contain information generated during the session, information regarding previous sessions, and preferences indicated by a participant in the collaborative session or a system administrator. The particularized content may be synchronized on a peer-to-peer basis as well as through server intervention. The user for which the particularized content is targeted may maintain controls over when and to whom the particularized content may be shared.

In embodiments, upon the initiation of a co-browsing session at a website, previous activities and/or preferences from the first user may be used to populate the browser of the first user. Notably, this population data may also be used to populate the browser of a second user such that the browsers of the first user and the second user are synched in part or in full during a co-browsing session. Thus, the manner in which, when, and the particulars for identifying and synchronizing personalized content between users may vary in embodiments of the invention.

In embodiments, the instructions or steps, may provide for determining that a first user has established a remote server sponsored session, determining that particularized user content is associated with the first user, supporting a collaborative session between the first user and a second user, the first user being the primary user and the second user being a subordinate user, manipulating particularized user content of the first user using collaborative session instructions, the particularized user content of the first user for synchronization of content between the first user and the second user during a collaborative session, and during a collaborative session between the first user and the second user, providing the particularized user content of the first user to the second user, the particularized content of the first user for replacing content previously provided to the second user.

In embodiments the instructions or steps may further provide for retrieving personalized user content of the first user from the second user, receiving collaborative session instructions from the first user providing rules for sharing particularized user content from the first user with another user, initiating a collaborative session between the first user and the second user, tagging particularized user content, and searching for tags when determining that particularized user content is associated with the first user.

Still further embodiments may include a website being the target of the collaborative session, default collaborative session preferences previously selected by the first user or an administrator, and authenticating the second user prior to sending the second user particularized user content of the first user. Other steps, methods, devices, and articles may also be employed in embodiments of the invention.

### BRIEF DESCRIPTION OF THE SEVERAL VIEWS OF THE DRAWINGS

FIG. 1A shows an exemplary screen shot of a web browser for a first user engaged in a co-browsing session in accord with embodiments of the invention.

FIG. 1B shows an exemplary screen shot of a web browser for a second user engaged in a co-browsing session in accord with embodiments of the invention.

FIG. 2 shows a system of clients and servers, coupled through a network, which may be employed in accord with embodiments of the invention.

FIG. 3 shows instruction requests that may be generated and displayed to users in accord with embodiments of the invention.

FIG. 4 shows methods that may be employed in accord with embodiments of the invention.

FIG. 5 shows methods that may be employed in accord with embodiments of the invention.

FIG. 6 shows a network, with various devices that may be used in accord with embodiments of the invention.

### DETAILED DESCRIPTION

Embodiments include systems, methods, apparatus, and articles of manufacture related to and regarding collaborative sessions, sharing content particularized for a user participating in a collaborative session, and managing the sharing of user specific content among and between participants in a collaborative session. The collaborative sessions may be conducted at the application layer with HTTP or other protocols being used for application level communications between two users and a remote server. In an embodiment this communication may include employing an HTML browser in order to access a retail shopping website over the world wide web. Receiving information from that server, and displaying that information in a co-browsing session attended by at least two users.

In an exemplary embodiment, a remote server may generate content specific for a first user. This specific content, which may be referred to as Particularized User Content (PUC) may include information from the last session the user had with the server as well as default conditions or preferences unique to or selected by the first user. Provided that the first user has given proper authorization, in embodiments, the Personalized User Content may be shared with a second user when the second user participates in a collaborative session with the first user. This synching may function to replicate the session of the first user for the second user. This replication may be in real-time or with a prescribed delay.

Upon the conclusion of the collaborative session the Personalized User Content may be retracted from the second user and the second user's session may be returned to a pre-collaboration state or to a state distinct from the collaborative session. In embodiments, the specific Personalized User Content available to collaborators may be selected by the applicable first user. This selectivity may include limiting topics of information that may be made available, limits or parameters of access by certain collaborative users, and temporal limits when accessing Personalized User Content.

In embodiments, a user may be prompted at the beginning of a collaborative session, or before another user joins the collaborative session, to determine how Personalized User Content should be managed and protected. Based on the received instructions, the Personalized User Content may be so managed by a server or a user agent. In embodiments, the Personalized User Content may be shared between collaborating users and may be shared from the server with each user authorized or designated to receive the Personalized User Content. The PUC may be shared according to its content and in a view-only manner. This view-only manner may be used to prevent a collaborative user from executing links or selectors available to the fist user Personalized User Content. The Personalized User Content can include information from a user's previous session with the server, default selections made by a user, selections made by a user during a session. A user may be prompted to provide instructions during a session as to how Personalized User Content should be managed for the session. An administrator may, too, provide instructions as to how Personalized User Content should be managed for the session.

In embodiments a communication enabled application feature pack may use widgets or other modules to provide a collaborative browsing session. In these sessions two users may join a collaboration session to co-browse a website with one user driving the session. Information like URLs, clicked html elements, etc. may be passed back and forth to keep the two user's views synchronized. In order to further synchronize the users, and to account for situations where users may not be returned to exact versions of a webpage, the personalized content of the first user may be shared with the personalized content of the second user.

For example, in a Customer/Customer Service Representative environment the customer's webpage version may contain a section for suggested products based on their previous purchases. This Personalized User Content, may be displayed for the CSR when carrying out embodiments of the invention. In embodiments, the user may send HTML snippets to the CSR and the CSR may have a widget that acts to replace existing content with the new HTML snippets. In embodiments, it may be preferred to disable action items in the snippet such that the CSR may not act in the place of the Customer and place an order inadvertently.

In embodiments, a collaboration session may be established. As pages are loaded for viewing or use in the collaborative session, Personalized User Content may be identified for a user. The Personalized User Content may be identified through pre-tagging or through a test that identifies personal content to be displayed. When a page with Personalized User Content is loaded, the target of the Personalized User Content may be prompted to determine whether other users in the collaborative session may receive the Personalized User Content. When affirmative authorizations are received, the Personalized User Content may be sent to and shared with other co-browsers.

In embodiments, the Personalized User Content may be sent by a module at the primary user that clones the Personalized User Content and send it back through the server to the co-browser. Upon receipt by the co-browser, the Personalized User Content may replace existing content such that the collaborative browsing sessions for each user are synchronized. In embodiments, content removed from the second user may be restored at the end of the co-browsing session.

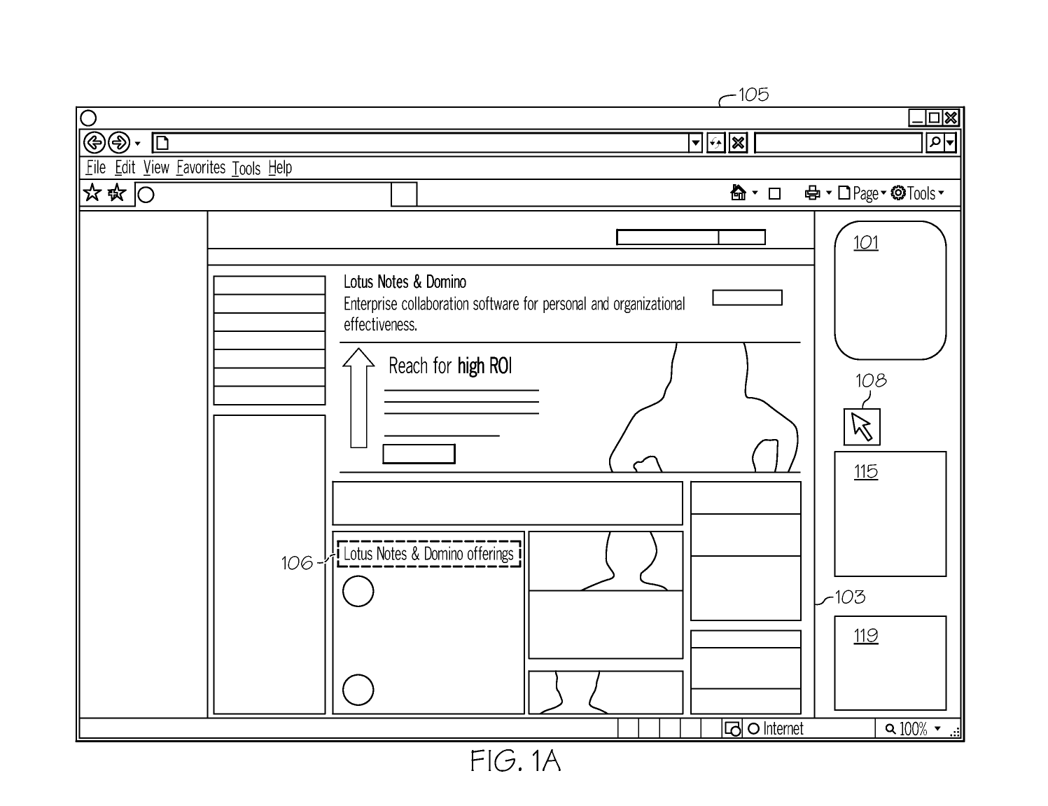

FIG. 1A and FIG. 1B show screen shots of users involved in a co-browsing session according to embodiments of the invention. Co-browsing sessions may differ from proxy sessions in that each peer in the session may be interacting with the server or other source of displayed browser information. Browser commands, steps, and instructions carried out by one user may be replicated on a peer's browser. This replication may include communications between the server and each peer, rather than a peer-to-peer type of proxy or screen share.

FIG. 1B shows the screen of a peer involved in a co-browsing session with the peer user whose screen is shown in FIG. 1A. As can be seen, each user's screen includes an open browser 105 and 115, in this case Windows® Explorer. Within each browser is an open web page 103 and 113, and in each web page is a copy/paste highlighted material 106 and 116.

In this embodiment, FIG. 1A represents the screen shot of an initial user and FIG. 1B shows the screen of a second user after Personalized User Content has been shared with the second user. As can be seen, once the co-browsing session is underway, each user may see the same portions of the web site being viewed, the same location of the pointer 108 and 118, and the same highlighted material 106 and 116. Thus, the screens of the initial user and the invitee are essentially synchronized and may remain synchronized during the co-browsing session. During the co-browsing session, as one user moves his or her cursor, those movements may be replicated on a co-browser's display. When shopping websites are being browsed, this synchronization may be helpful or advantageous to the experience.

Synchronization may occur through the web server, through communication between clients, as well through other methods. Moreover, this synchronization may also occur in real-time as well as with some network, server, or processing related delay. For example, the first user's browsing session may be delayed six hours, such that time zone distances between user's can be accommodated.

Personalized User Content is shown in FIG. 1A at 101, 115, and 119. This PUC may be pictures, lists of previously shopped items, wish lists for sale items, and various other things associated with a particular user. As can be seen, PUCs 101 and 115 have been shared with the co-browser of FIG. 1B. In this embodiment, the user of FIG. 1A authorized that Personalized User Content reflected in 101 and 115 be shared with the user viewing FIG. 1B. Likewise, the user of FIG. 1A did not authorize the sharing of Personalized User Content 119 with the user of FIG. 1B. As can be seen, FIG. 1B shows item 120 instead of Personalized User Content 119 from FIG. 1A.

In embodiments, the Personalized User Content may be shared in various ways and various configurations. These varieties may be set by user preference and instructions. Automated provisions may also be used to set the Personalized User Content that is shared between users. These automated provisions may include using information from an IP address, a user's search habits, security authorizations of a recipient, or other criteria when specifying Personalized User Content to be shared or to be blocked from sharing.

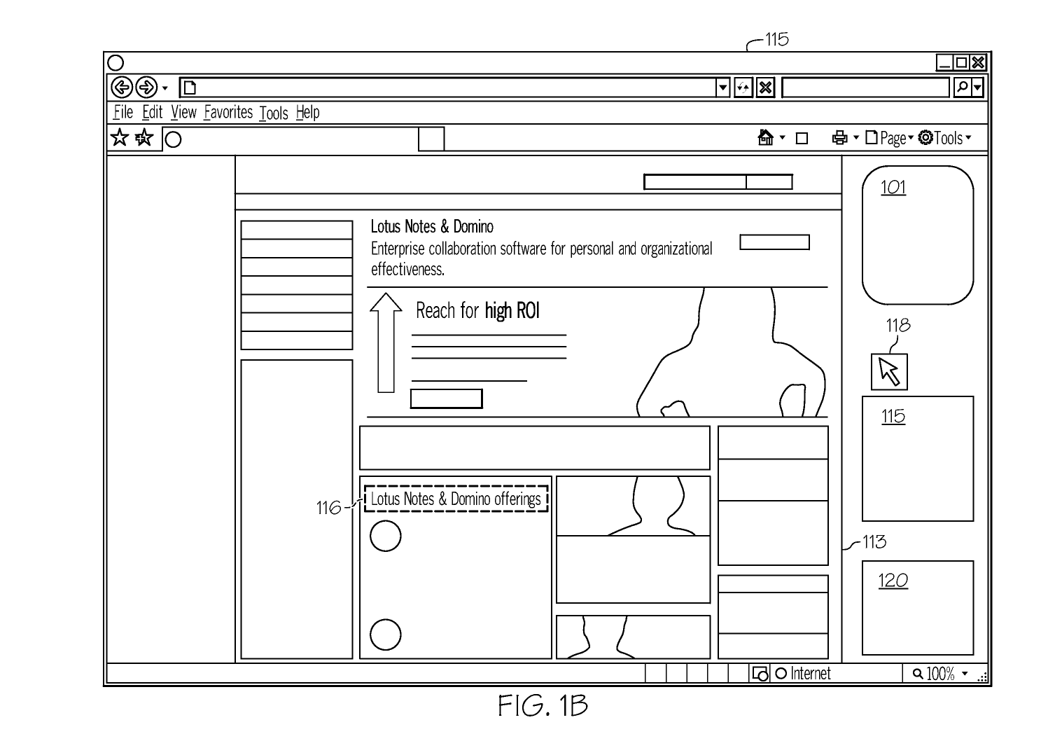

FIG. 2 shows a server and client network configuration that may be employed in embodiments of the invention. The clients 205 and 210 may each be accessible to the network 200, which is itself accessible to the servers 215 and 220. In embodiments, the client 205 may be running an HTML web browser and may be accessing information on server 215, which is serving as a web server. The web server may employ a Personalized User Content module that acts to synchronize Personalized User Content between co-browsers. The Personalized User Content module may monitor when Personalized User Content is generated and sent to a first user and may act to send that same Personalized User Content or similar Personalized User Content to a co-browser in accord with standing or received instructions. A Personalized User Content module may also be resident in the clients 215 and 210 such that PUC may be exchanged between them, through the servers, with or without server intervention. In other words, a server may identify to a user that Personalized User Content has been sent to the user and the Personalized User Content module at the receiving user may then act to have that content synchronized with a co-browser of another user.

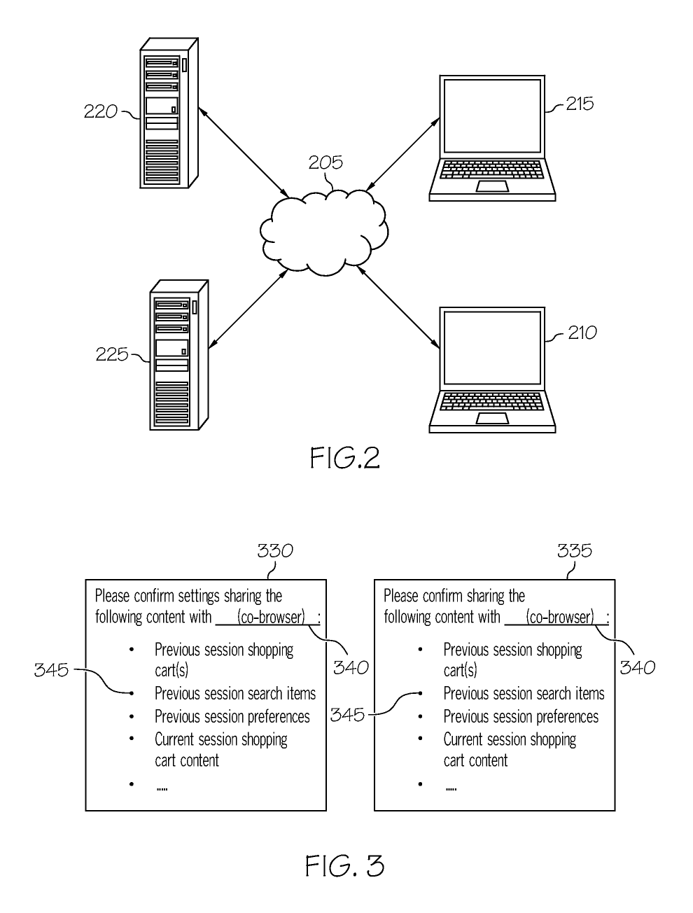

FIG. 3 shows examples of queries and invitations that may be employed in accord with embodiments of the invention. 330 and 335 show queries that may be generated from a plug-in or co-browse Personalized User Content module. The plug-in may be client side or server side. Queries may be generated when a co-browse session is started, when Personalized User Content is identified to be sent to a co-browser, and at other times as well. As can be seen, a list 345 of Personalized User Content may be presented for the user to select from. The identify 340 of the co-browser, who will be receiving authorization to receive the Personalized User Content, may be identified in the invitation as well. In embodiments, a counter may be employed such that a user may receive only a certain number of queries or invitations during a browsing session or during some other defined period. Likewise, the counter may limit the queries generated for a certain website or user. Still further, the queries can prompt the user for instructions for Personalized User Content to be shared or for instructions on how to handle future Personalized User Content to be shared.

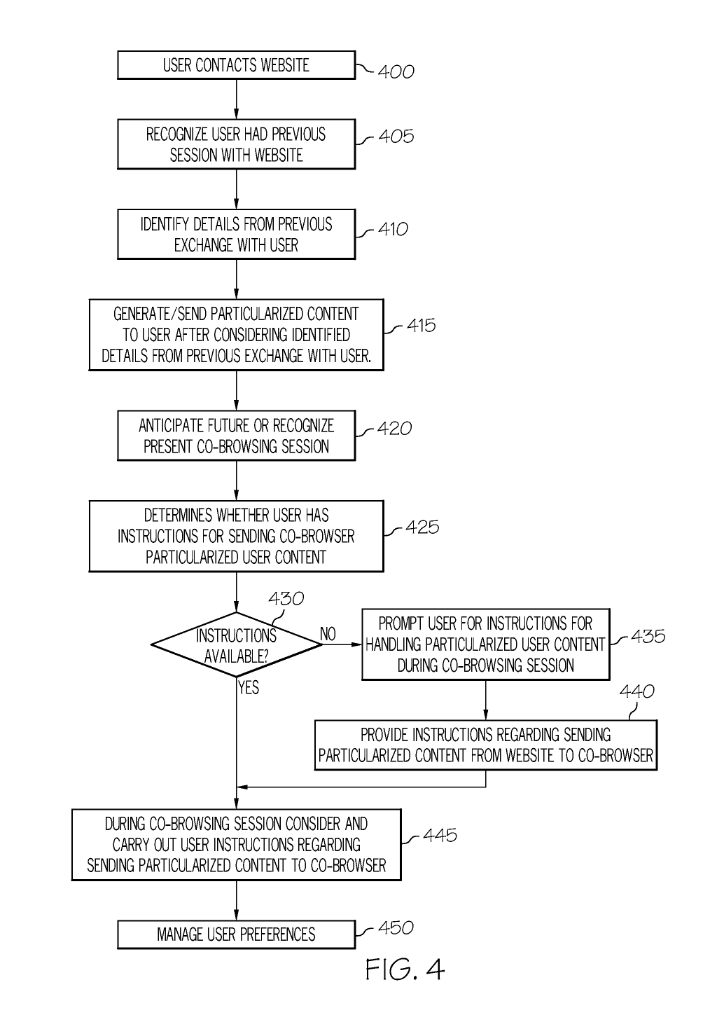

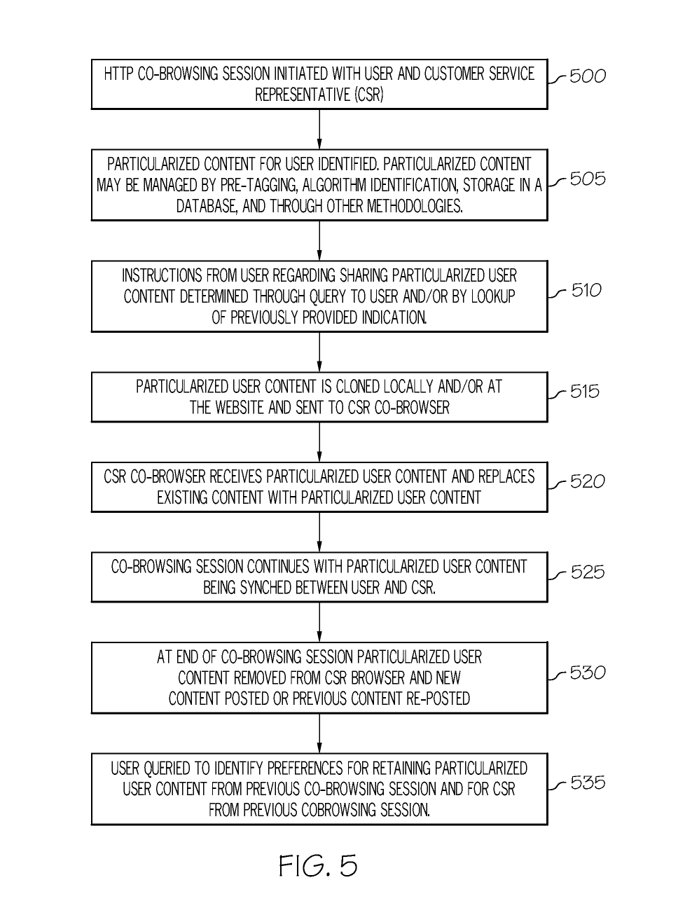

FIGS. 4 and 5 show actions that may be employed in accord with embodiments of the invention. Embodiments may include other actions as well, may include fewer than those specifically enumerated, and may include alterations to those enumerated in FIGS. 4 and 5 and elsewhere in the application. As can be seen in FIG. 4, a user may contact the website at 400. The website, at 405, may recognize that the user has had a previous session with the website and may identify the details from the previous exchange with the user at 410. These details may include particularized content specific to the user that may be used to customize the user's experience at their website. The generation and transmittal of this particularized content is shown at 415.

At the beginning or sometime during the browsing session between the user and the website a co-browsing session may begin. This co-browsing session may be between a single user and the original user as well as between the original user and several subsequent users. Once a co-browsing session request is sensed a determination may be made as to whether or not the user has provided instructions as to how to handle particularized user content. This determination is shown at 425. If no instructions are available a user may be prompted for instructions as to how to handle particularized user content during the co-browsing session. This is shown at 435. Subsequent to this prompt, as shown at 440, the user may provide instructions as to how to send the particularized content from the website to a co-browser. As shown at 445, the co-browsing session may be carried out using user instructions as to how to handle particularized user content. The co-browsing session may continue subsequent to this such that the instructions in other user preferences are managed for the ongoing co-browsing session as well as for subsequent co-browsing sessions that the user may participate in.

While a co-browsing session has been explained with respect to FIG. 4, other collaborative sessions may be employed in accord with embodiments of the invention as well. For example, FTP file transfer, which is done on a collaborative basis between two different users at two different computers sending information to a server may also employ embodiments of the invention. In this example, database structures or other specific content a user may be shared with a co-browser, such that the co-browser can send relevant and pertinent information in the FTP file transfer.

In a preferred embodiment the browser being employed may be an HTML browser employing HTTP protocol communications to a server. However, other application layers and other local client applications may also be used to carry out embodiments of the edge. Still further, embodiments of the invention may be carried out in modules loaded onto these various server-side and client-side applications. These modules, as described above, may include Servlets, Applets, widgets, JavaScript, and other available coding mechanism.

FIG. 5 shows actions as may be employed in a method in accord with embodiments. At 500, an HTTP co-browsing session may be initiated as between the user and a customer service representative. A server facilitating the session may authenticate each user including verifying the requisite passwords for the user and certificates prior to or during the initiation of the co-browsing session. The server facilitating the session may perform other functions as well. As particularized content is identified for the user the content may be selectively shared with the consumer service representative. The particularized content may be identified by pre-tagging, tests assigned to identify the particularized content, by retreaving the particularized content from a database, and by other methodologies as well. At 510, a Personalized User Content module may act to identify and received instructions from user regarding how to share particular eyes user content associated with that user. This may include a query to the user as well as a lookup of previously provided indicators regarding that user. As shown at 515, identified particularize user content ready to be shared with the consumer service representative may be cloned locally or at the website and may be sent to the consumer service representative for use in his or her browsing session. The consumer service representative, as shown at 520, may receive the particularized content and substitute out existing content such that the website for the consumer service are presented may more closely match or be synchronized with the consumer. As the co-browsing session continues, as shown at 525, the browsers as well as the server may work together to continue to identify and synchronize particularized user content. At 530, at the end of the browsing session, particularize user content may be removed from the service representative browser such that the CSR is returned back to a state prior to beginning the co-browsing session with the customer. At 535, during or after a co-browsing session, the user/customer may be queried to identify preferences for retaining particularized user content from previous co-browsing sessions such a CSR or other co-browser may have certain limited access to that particular eyes user content.

As noted above, the particularized user content may be limited or sifted such that confidential information is not shared, sensitive information is not shared, untimely information is not shared, or other limits or parameters are placed on the sharing as well. In so doing, a user may maintain privacy or secrecy over previous sessions while the same time in some embodiments being able to share relevant information with a CSR in order to receive timely and accurate advice.

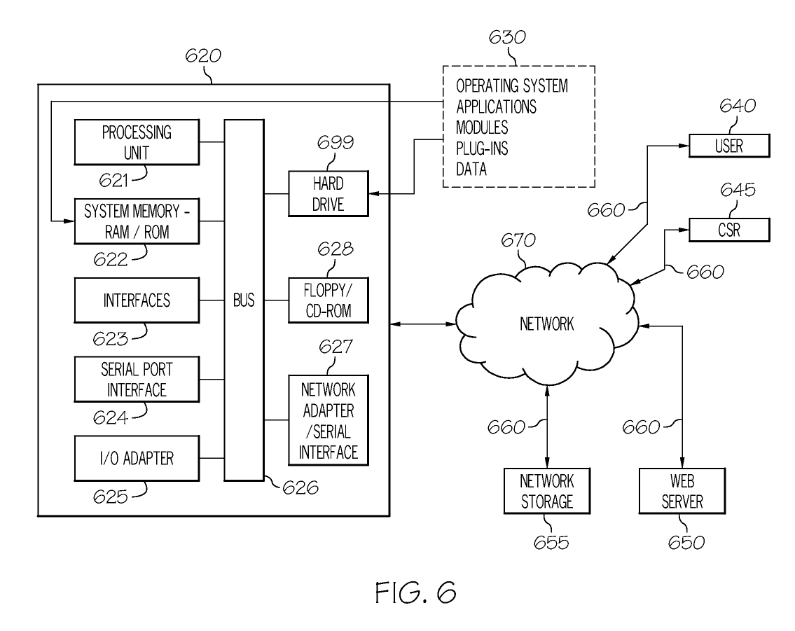

FIG. 6 shows a system that may be employed by embodiments of the invention. This system may include a server 620 having instructions 630; a user 640, a CSR 645; a network 670; network storage 655; and a web server 650. As can be seen, the clients and servers may communicate over and through the network 670. The client or server, which is exemplary of each of the clients and servers, may store, on hard-drive memory 699 and system memory 622, instructions 630 for employing the PUC module described throughout. Also visible in the client or server 620 are the interfaces 624, I/O adapter 625, removable disk drives 628, and network adapter 627. Each may communicate via the bus 626. The Personalized User Content module may also be resident in the hard drive 699, the RAM/ROM 622 as well as at the user 660 and the Consumer Representative 645. Resident in memory, the instructions may be carried out by the processing units of the server 620, the user 640, and the CSR 645.

As noted embodiments of the invention may include the use of a module configured to assist in or facilitate the management of Personalized User Content in a collaborative session. The module may be configured in various ways and may be resident at a user agent, at a server, or both. The module may be employed as an Applet, a Widget, in embedded JavaScript, and through numerous other methodologies as well.

While it is understood that the process software embodying the invention may be deployed by manually loading directly in the client, server and proxy computers via loading a storage medium such as a CD, DVD, etc., the process software may also be automatically or semi-automatically deployed into a computer system by sending the process software to a central server or a group of central servers. The process software is then downloaded into the client computers that will execute the process software. Alternatively the process software may be sent directly to the client system via e-mail. The process software is then either detached to a directory or loaded into a directory by a button on the e-mail that executes a program that detaches the process software into a directory. Another alternative is to send the process software directly to a directory on the client computer hard drive. When there are proxy servers, the process will, select the proxy server code, determine on which computers to place the proxy servers' code, transmit the proxy server code, then install the proxy server code on the proxy computer. The process software will be transmitted to the proxy server then stored on the proxy server.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof.

Embodiments may be implemented as a computer process, a computing system or as an article of manufacture such as a computer program product of computer readable media. The computer program product may be a computer storage medium readable by a computer system and encoding a computer program instructions for executing a computer process.

The description of the present invention has been presented for purposes of illustration and description, but is not intended to be exhaustive or limited to the invention in the form disclosed. Many modifications and variations will be apparent to those of ordinary skill without departing from the scope and spirit of the invention. The embodiments were chosen and described in order to best explain the principles of the invention and the practical application, and to enable others of ordinary skill in the art to understand the invention for embodiments with various modifications as are suited to the particular use contemplated.

What is claimed is:

1. An article of manufacture comprising:
a non-volatile computer readable medium, the computer readable medium storing instructions thereon, which when executed, comprise:
determining that a first user has established a remote server sponsored session;
determining that particularized user content is associated with the first user;
supporting a collaborative session between the first user and a second user, the first user being the primary user and the second user being a subordinate user;
manipulating particularized user content of the first user using collaborative session instructions, the particularized user content of the first user for synchronization of content between the first user and the second user during a collaborative session; and
during a collaborative session between the first user and the second user, providing the particularized user content of the first user to the second user, the particularized content of the first user for replacing content previously provided to the second user.

2. The article of claim 1 storing instructions, which when executed, further comprise:
retrieving personalized user content of the first user from the second user.

3. The article of claim 1 storing instructions, which when executed, further comprise:
at the inception of a collaborative session, receiving collaborative session instructions from the first user providing rules for sharing particularized user content from the first user with another user, the rules restricting access to certain particularized user content.

4. The article of claim 1 storing instructions, which when executed, further comprise:
initiating a collaborative session between the first user and the second user,
wherein the collaborative session is directed to a website,
wherein the collaborative session includes the first user and the second user co-browsing the website.

5. The article of claim 1 storing instructions, which when executed, further comprise:
tagging particularized user content; and
searching for tags when determining that particularized user content is associated with the first user.

6. The article of claim 1 storing instructions, wherein the second user is a consumer service representative, and wherein the personal user content comprises at least one of:
the identity of a product previously searched by the first user on a website, the website being the target of the collaborative session;
the identity of a product previously purchased by the first user on a website, the website being the target of the collaborative session; and
default collaborative session preferences previously selected by the first user or an administrator.

7. The article of claim 1, storing instructions, which when executed, further comprise:
authenticating the second user prior to sending the second user particularized user content of the first user.

8. The article of claim 1, storing instructions, which when executed, further comprise:
retrieving particularized user content of the first user from the first user;
retrieving particularized user content of the first user from a database; and
generating particularized user content of the first user consistent with rules established by a system administrator or the first user.

9. A method comprising:
determining that a first user has established a remote server sponsored session;
determining that particularized user content is associated with the first user;
supporting a collaborative session between the first user and a second user, the first user being the primary user and the second user being a subordinate user;
manipulating particularized user content of the first user using collaborative session instructions, the particularized user content of the first user for synchronization of content between the first user and the second user during a collaborative session; and
during a collaborative session between the first user and the second user, providing the particularized user content of the first user to the second user, the particularized content of the first user for replacing content previously provided to the second user.

10. The method of claim 9 further comprising:
retrieving personalized user content of the first user from the second user.

11. The method of claim 9 further comprising:
at the inception of a collaborative session, receiving collaborative session instructions from the first user providing rules for sharing particularized user content from the first user with another user, the rules restricting access to certain particularized user content.

12. The method of claim 9 further comprising:
initiating a collaborative session between the first user and the second user,
wherein the collaborative session is directed to a website,
wherein the collaborative session includes the first user and the second user co-browsing the website.

13. The method of claim 9 further comprising:
tagging particularized user content; and
searching for tags when determining that particularized user content is associated with the first user.

14. The method of claim 9, wherein the second user is a consumer service representative, and wherein the personal user content comprises at least one of:
the identity of a product previously searched by the first user on a website, the website being the target of the collaborative session;
the identity of a product previously purchased by the first user on a website, the website being the target of the collaborative session; and
default collaborative session preferences previously selected by the first user or an administrator.

15. The method of claim 9, further comprising:
authenticating the second user prior to sending the second user particularized user content of the first user.

16. The method of claim 9, further comprising:
retrieving particularized user content of the first user from the first user;
retrieving particularized user content of the first user from a database; and
generating particularized user content of the first user consistent with rules established by a system administrator or the first user.

17. An article of manufacture comprising:
a non-volatile computer readable medium, the computer readable medium storing instructions thereon, which when executed, comprise:
determining that a first user has established a remote server sponsored session;
determining that particularized user content is associated with the first user;
supporting a collaborative session between the first user and a second user, the first user being the primary user and the second user being a subordinate user;
manipulating particularized user content of the first user using collaborative session instructions, the particularized user content of the first user for synchronization of content between the first user and the second user during a collaborative session; and
during a collaborative session between the first user and the second user, providing the particularized user content of the first user to the second user, the particularized content of the first user for replacing content previously provided to the second user.

18. The computer of claim 17 storing instructions, which when executed, further comprise:
retrieving personalized user content of the first user from the second user.

19. The computer of claim 17 storing instructions, which when executed, further comprise:
at the inception of a collaborative session, receiving collaborative session instructions from the first user providing rules for sharing particularized user content from the first user with another user, the rules restricting access to certain particularized user content.

20. The computer of claim 17 storing instructions, which when executed, further comprise:
initiating a collaborative session between the first user and the second user,
wherein the collaborative session is directed to a website,
wherein the collaborative session includes the first user and the second user co-browsing the website.
